(19) United States
(12) Patent Application Publication
(10) Pub. No.: US 2014/0149950 A1
(43) Pub. Date: May 29, 2014

(54) IMAGE OVERLAY-BASED USER INTERFACE APPARATUS AND METHOD

(71) Applicant: SAMSUNG ELECTRONICS CO., LTD., (unknown)

(72) Inventors: Min-Young MUN, Seoul (KR); Eun-Sung JUNG, Yongin-si (KR)

(73) Assignee: SAMSUNG ELECTRONICS CO., LTD.

(21) Appl. No.: 14/022,440

(22) Filed: Sep. 10, 2013

(30) Foreign Application Priority Data
Nov. 29, 2012 (KR) 10-2012-0137207

(51) Int. Cl. G06F 3/01

(52) U.S. Cl. CPC G06F 3/017
USPC 715/863

(57) ABSTRACT

An apparatus includes a display unit configured to display a user interface screen in an area, and a sensing unit configured to capture an image of a motion of an object used to enter user input. The apparatus further includes an input recognition unit configured to lay the image over the user interface screen, and recognize the user input based on the image laid over the user interface screen, and a processing unit configured to process an operation corresponding to the recognized user input.

### CROSS-REFERENCE TO RELATED APPLICATION

This application claims the benefit under 35 USC 119(a) of Korean Patent Application No. 10-2012-0137207, filed on Nov. 29, 2012, in the Korean Intellectual Property Office, the entire disclosure of which is incorporated herein by reference for all purposes.

### BACKGROUND

1. Field

The following description relates to an image overlay-based user interface apparatus and method.

2. Description of the Related Art

Most terminals (such as smartphones and tablet personal computers (PCs)) provide tools (such as touchpads) to be used to enter user input. Accordingly, users can enter various inputs into their terminals to make their terminals perform various operations. On the other hand, wearable devices (for example, glasses-type wearable devices) are either not equipped with user input tools or only provide limited-size user input tools. Accordingly, wearable devices may not be as suitable for keyboards to be used to enter user input, and may be suited, at best, to recognize gesture-based user input and perform simple operations. There are many occasions when it is difficult or even inappropriate to enter user input through voice- or gesture-recognition due to, for example, the surroundings. Also, entering user input to terminals through voice- or gesture-recognition may be associated with privacy and security concerns.

### SUMMARY

In one general aspect, there is provided an apparatus including a display unit configured to display a user interface screen in an area, and a sensing unit configured to capture an image of a motion of an object used to enter user input. The apparatus further includes an input recognition unit configured to lay the image over the user interface screen, and recognize the user input based on the image laid over the user interface screen, and a processing unit configured to process an operation corresponding to the recognized user input.

In another general aspect, there is provided a method including displaying a user interface screen in an area, and capturing an image of a motion of an object used to enter user input. The method further includes laying the image over the user interface screen, recognizing the user input based on the image laid over the user interface screen, and processing an operation corresponding to the recognized user input.

Other features and aspects will be apparent from the following detailed description, the drawings, and the claims.

### BRIEF DESCRIPTION OF THE DRAWINGS

FIGS. 1A and 1B are diagrams illustrating an example of an application of an image overlay-based user interface apparatus.

FIG. 2 is a block diagram illustrating an example of an image overlay-based user interface apparatus.

FIGS. 3A to 3C are diagrams illustrating examples of a user interface screen displayed in a display area.

FIG. 4 is a flowchart illustrating an example of an image overlay-based user interface method.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

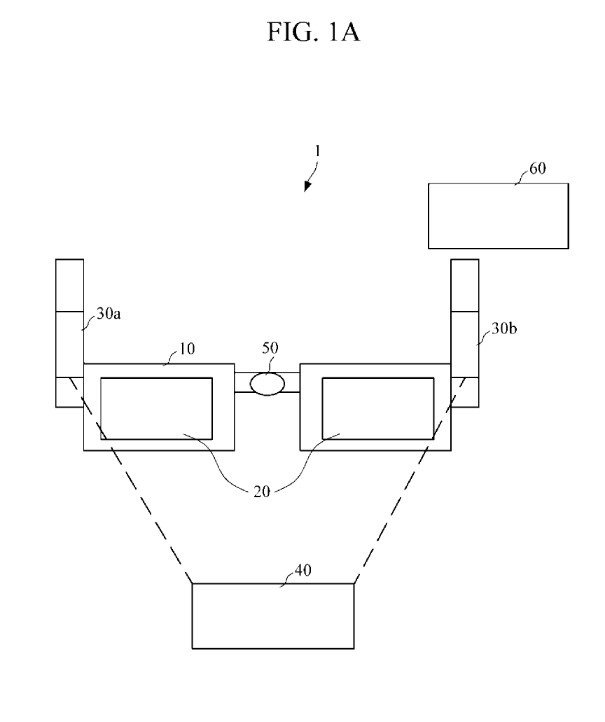

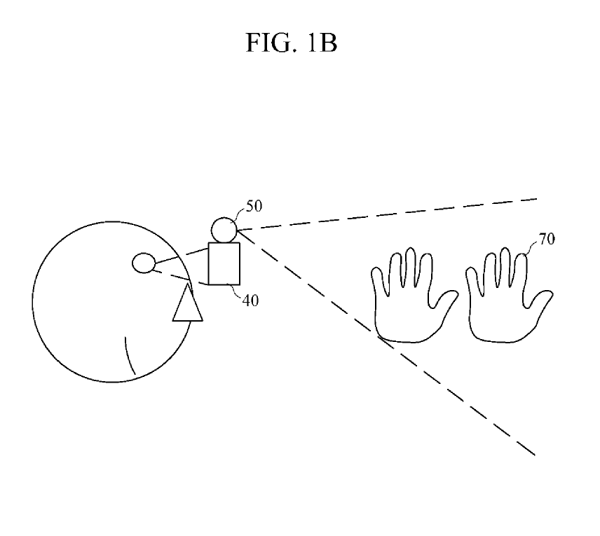

FIGS. 1A and 1B are diagrams illustrating an example of an application of an image overlay-based user interface apparatus. Referring to FIGS. 1A and 1B, the user interface apparatus is applied to a glasses-type wearable device 1 that may be worn on a face of a user. The user interface apparatus may also be applied to a wearable device of any type (other than a glasses type), such as, for example, a vest type.

The glasses-type wearable device 1 does not include a physical device (such as, for example, a touchpad and/or a keyboard) to be used to transmit user input. The user interface apparatus may also be applied to a glasses-type wearable device including a physical device to be used to transmit user input.

The glasses-type wearable device 1 includes a frame 10, lenses 20, display units 30a and 30b, a sensing unit 50, and a processing unit 60. The display units 30a and 30b (such as, for example, micro projectors) are disposed at respective positions on the frame 10. The display units 30a and 30b generate a display area 40 that may only be viewed by the user who is wearing the wearable device 1, and the user may view a user interface screen displayed in the display area 40 through the lenses 20. The display units 30a and 30b are illustrated in FIG. 1A as being disposed on respective sides of the frame 10, but may both be disposed on the same side of the frame 10.

In more detail, the display units 30a and 30b may generate the display area 40 in a virtual space near eyes of the user so that the display area 40 may only be viewed by the user who is wearing the wearable device 1. The display area 40 may be generated at an optimum location determined based on a size of the user interface screen to be displayed and an eyesight of the user. The user may control the display units 30a and 30b to adjust the location of the display area 40. The display units 30a and 30b may display the user interface screen in the display area 40 so that the user may enter input.

The sensing unit 50 including an image capture device (such as, for example, a camera) is disposed on the frame 10. Referring to FIG. 1B, the user enters user input through the user interface screen in the display area 40 by moving an input tool 70 or object (such as, for example, a hand, a finger, and/or a stylus pen) within a viewing angle of the sensing unit 50. The sensing unit 50 detects the input tool 70, and obtains an image of the motion of the input tool 70.

In other examples, the sensing unit 50 may detect a distance between the wearable device 1 and the input tool 70. The sensing unit 50 may precisely recognize a push operation performed by the motion of the input tool 70, based on depth information including the detected distance between the wearable device 1 and the input tool 70. The sensing unit 50 may also include a sensor that easily detects the depth information, and the sensor may be a ring that may be worn on a finger of the user, or in a shape that may be attached to a fingernail of the user. The sensing unit 50 may also include a microphone that collects voice information from the user.

Referring to FIGS. 1A and 1B, the processing unit 60 (such as, for example, a processor) recognizes user input based on the image of the motion of the input tool 70 that is obtained by the sensing unit 50, and processes an operation corresponding to the recognized user input. The processing unit 60 may be disposed at a position on the frame 10. The processing unit 60 may include a processor of an external device (for example, a smartphone, a tablet personal computer (PC), a laptop computer, and/or a PC) with excellent computing performance to reduce a manufacturing cost of the user interface apparatus while improving a processing performance of the user interface apparatus.

In more detail, the processing unit 60 lays the image of the motion of the input tool 70 over the user interface screen displayed in the display area 40. The processing unit 60 recognizes user input based on the image of motion of the input tool 70 that is laid over the user interface screen, and processes an operation corresponding to the recognized user input.

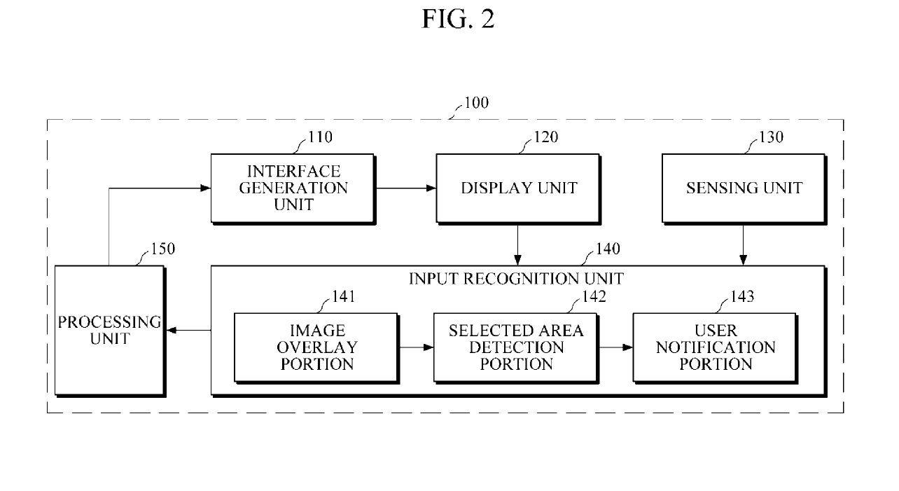

FIG. 2 is a block diagram illustrating an example of an image overlay-based user interface apparatus 100. Referring to FIG. 2, the user interface apparatus 100 includes an interface generation unit 110, a display unit 120, a sensing unit 130, an input recognition unit 140 and a processing unit 150. The input recognition unit 140 includes an image overlay portion 141, a selected area detection portion 142, and a user notification portion 143, and may be implemented as a module that forms the processing unit 150.

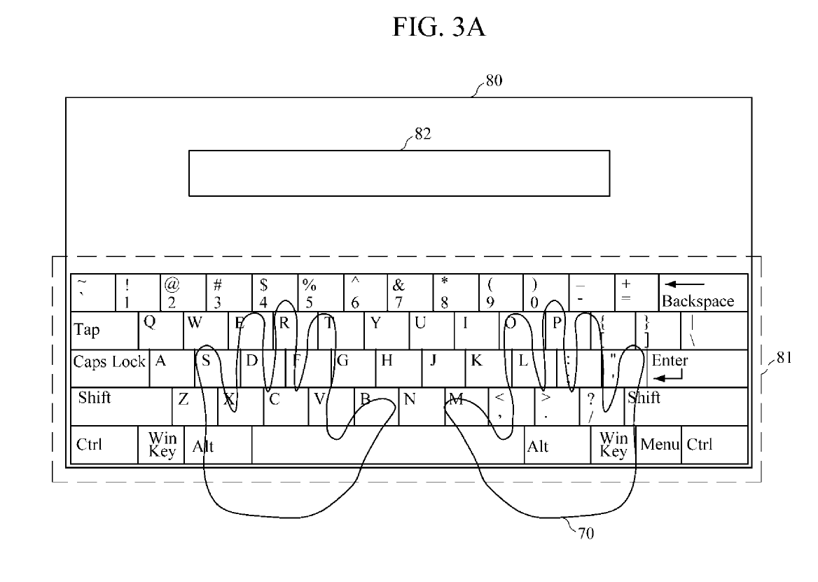

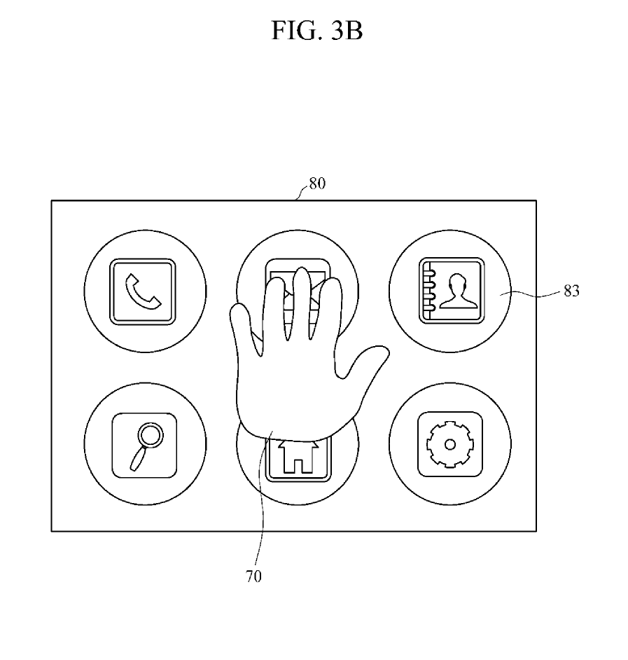

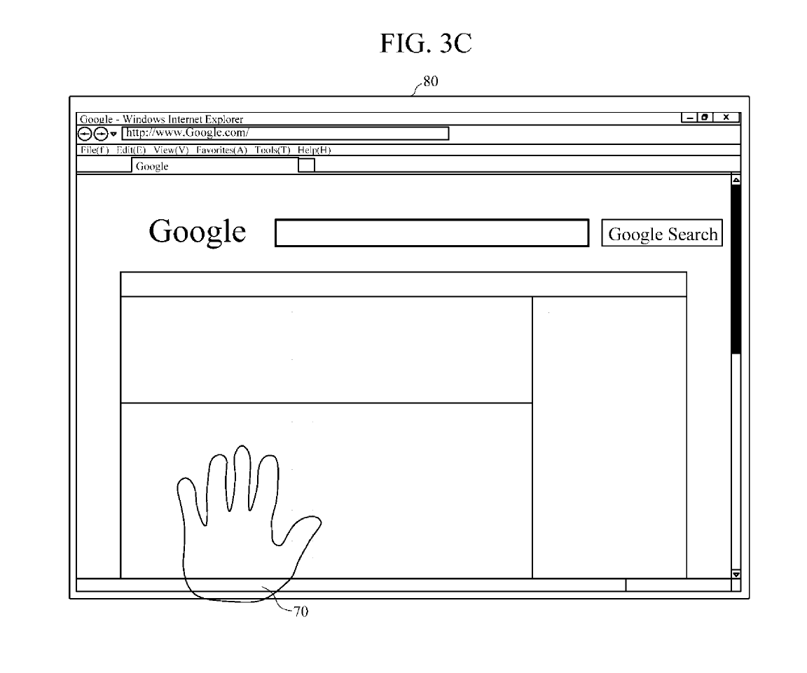

The interface generation unit 110 generates a user interface screen to be displayed in a display area. The user interface screen may be generated in various forms, as illustrated in FIGS. 3A to 3C. The user interface screen may include any type of screen that may be displayed on, for example, a mobile terminal, a tablet PC, a laptop computer, and/or other devices known to one of ordinary skill in the art. In one example, the user interface screen may include a menu screen to be used by a user to control the user interface apparatus 100 or an external device connected to the user interface apparatus 100 in a wired or wireless manner. In another example, the user interface screen may include a key input screen to be used by the user to enter various characters. In still another example, the user interface screen may include an application-related screen (for example, a web browser screen, a game screen, and/or a media player screen) that may be displayed in connection with an execution of an application in either the user interface apparatus 100 or an external device connected to the user interface apparatus 100 in a wired or wireless manner.

FIGS. 3A to 3C are diagrams illustrating examples of a user interface screen 80 displayed in a display area. Referring to FIG. 3A, the user interface screen 80 includes a key input screen. The key input screen includes a first area 81 in which a keyboard is displayed, and a second area 82 in which one or more characters selected from the keyboard by the user via the input tool 70 may be displayed. That is, in response to the user selecting the characters from the keyboard in the first area 81 by manipulating or moving the input tool 70 so that the image of the motion of the input tool 70 is over the characters, the selected characters may be displayed in the second area 82.

Referring to FIG. 3B, the user interface screen 80 includes a menu screen. The menu screen includes various graphic objects 83, such as, for example, icons. In response to a user selecting one of the graphic objects 83 by manipulating or moving the input tool 70 so that the image of the motion of the input tool 70 is over the one of the graphic objects 83, an operation corresponding to the selected one of the graphic objects 83 may be performed.

Referring to FIG. 3C, the user interface screen 80 includes a web browser screen. In response to a user clicking on a link on the web browser screen by manipulating or moving the input tool 70 so that the image of the motion of the input tool 70 is over the link, a screen corresponding to the link may be displayed in a display area as the user interface screen 80.

Referring back to FIG. 2, the display unit 120 displays the user interface screen generated by the interface generation unit 110 in the display area. The display unit 120 may generate the display area in a virtual space that may only be seen by the user who is using the user interface apparatus 100.

In response to the user moving an input tool (e.g., 70 of FIG. 1B) within the viewing angle of the image capture device to enter input, the sensing unit 130 including an image capture device detects the input tool in response to the user moving the input tool within a viewing angle of the sensing unit 130 to enter input. The sensing unit 130 captures an image of the motion of the input tool in real time, and transmits the captured image to the input recognition unit 140.

In other examples, the sensing unit 130 may obtain a distance between the user interface apparatus 100 and the input tool. The sensing unit 130 may include a sensor that obtains depth information including the distance between the user interface apparatus 100 and the input tool. The sensing unit 130 may also include a microphone that obtains voice information of the user.

The image overlay portion 141 lays the image of the motion of the input tool that is captured by the sensing unit 130, over the user interface screen displayed by the display unit 120. If a size of the captured image does not match a size of the display area, the image overlay portion 141 may optimize the captured image to fit the display area so that the user may feel as if the user is manipulating the input tool directly on the user interface screen even though the user is actually manipulating the input tool elsewhere. Accordingly, the user may precisely enter input even when no additional devices that may be used to enter the input (such as, for example, a touchpad and/or a keyboard) are provided.

The selected area detection portion 142 analyzes the image of the motion of the input tool that is laid over the user interface screen, and detects an area on the user interface screen that is selected by the user by manipulating or moving the input tool so that the image of the motion of the input tool is over the area, based on results of the analysis. The selected area detection portion 142 recognizes user input corresponding to the selected area on the user interface screen.

In response to the selected area on the user interface screen being detected by the selected area detection portion 142, the user notification portion 143 notifies the user that the user input corresponding to the selected area on the user interface screen has been recognized. In one example, the user notification portion 143 may display the selected area on the user interface screen in a different color from the rest of the user interface screen. In another example, the user notification portion 143 may display the selected area on the user interface screen 80 as being recessed. In still another example, the user notification portion 143 may enlarge the selected area on the user interface screen 80, and/or content (for example, text) displayed therein. In yet another example, the user notification portion 143 may output a beeping sound or a vibration when the user selects the area on the user interface screen 80.

The input recognition unit 140 may also include a voice analysis portion (not illustrated) that may analyze the voice information of the user that is obtained by the sensing unit 130. The voice analysis portion may recognize a voice of the user based on results of the analysis, and may recognize user input corresponding to the voice of the user.

In response the user input being recognized by the selected area detection portion 142 or the voice analysis portion, the processing unit 150 processes an operation corresponding to the recognized user input. In one example, referring to FIGS. 2 and 3A, in response to the characters being selected from the keyboard in the first area 81, the processing unit 150 may display the selected characters in the second area 82. In another example, referring to FIGS. 2 and 3B, in response to the one of the graphic objects 83 being selected from the menu screen, the processing unit 150 may process an operation corresponding to the selected one of the graphic objects 83. For example, the processing unit 150 may control the interface generation unit 110 to generate a new interface screen, if any, linked to the selected one of the graphic objects 83. In this example, the processing unit 150 may perform an inquiry with a database to fetch, from the database, data to be displayed on the new interface screen. In still another example, referring to FIGS. 2 and 3C, in response to the link on the web browser screen being clicked, the processing unit 150 may fetch, from the database, data to be displayed on a new interface screen linked to the clicked link, and may control the interface generation unit 110 to generate the new interface screen based on the data to be displayed on the new interface screen.

Referring again to FIG. 2, in response to the operation corresponding to the recognized user input being processed by the processing unit 150, the interface generation unit 110 may generate a new interface screen based on results of the processing. The display unit 120 may display the new interface screen in the display area.

In one example, the input recognition unit 140 and/or the processing unit 150 may be included in an external device, instead of the user interface apparatus 100, and may use computing resources in the external device. In this example, the user interface apparatus 100 may also include a communication unit (not illustrated) that may transmit various data, including, for example, the image of the motion of the input tool, to the external device connected to the user interface apparatus 100 in a wired or wireless manner. The communication unit may receive, from the external device, the results of the processing performed by the processing unit 150, for example.

In examples, a user may wear a wearable device including the user interface apparatus 100 to perform various operations that may be performed with a terminal, such as a smartphone and/or a tablet. In one example, the display unit 120 may display, in the display area, an initial menu screen generated in advance by the interface generation unit 110. The user may visit an Internet search website through the menu screen, and may perform an Internet search through the Internet search website.

In another example, in response to the user moving the input tool within the viewing angle of the sensing unit 130 to make a gesture indicating a visit to a predetermined Internet search website, the sensing unit 130 may obtain an image of the gesture, and the input recognition unit 140 may analyze the image of the gesture to recognize user input corresponding to the gesture. The processing unit 150 may fetch predetermined data to be displayed on a webpage screen linked to the predetermined Internet search website, and may control the interface generation unit 110 to generate the webpage screen based on the predetermined data. The display unit 120 may display the webpage screen in the display area. The user may perform an Internet search through the webpage screen by manipulating or moving the input tool.

In still another example, in response to the user issuing a voice command to perform an Internet search, the sensing unit 130 may obtain the voice command, and the input recognition unit 140 may analyze the voice command to recognize user input corresponding to the voice command. The processing unit 150 may fetch predetermined data to be displayed on a webpage screen linked to the Internet search, and may control the interface generation unit 110 to generate the webpage screen based on the predetermined data. The display unit 120 may display the webpage screen in the display area. The user may perform an Internet search through the webpage screen by manipulating or moving the input tool.

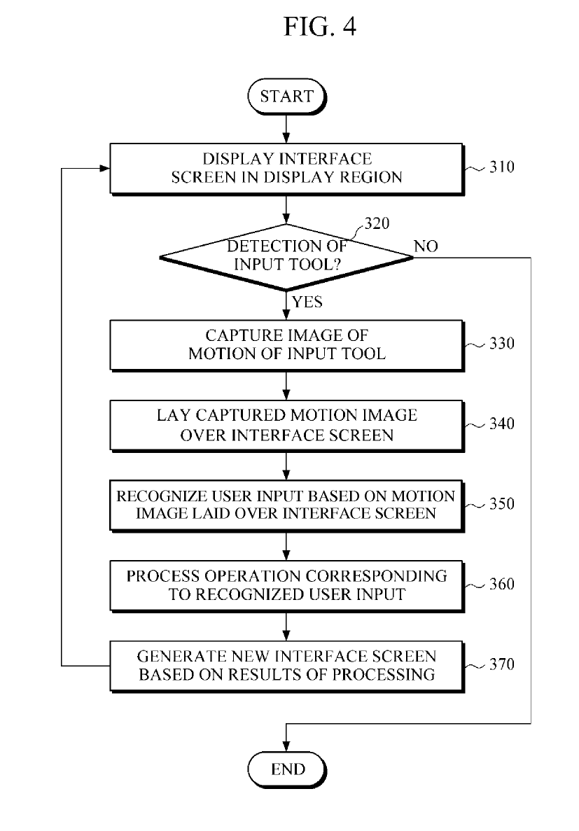

FIG. 4 is a flowchart illustrating an example of an image overlay-based user interface method. Referring to FIG. 4, a user may wear a wearable device to which an image overlay-based user interface apparatus (e.g., 100 of FIG. 2) is applied, and the user interface apparatus may perform the user interface method.

In operation 310, the user interface apparatus displays an interface screen in a display region or area. In one example, in response to the user issuing a voice command or entering a gesture with a use of an input tool (for example, a hand, a finger, and/or a pen of the user), the user interface apparatus may analyze the voice command or the gesture, and may display an interface screen corresponding to the voice command or the gesture in the display region.

The display region may be generated in a virtual space that may only be seen by the user using the user interface apparatus. As described above with reference to FIGS. 3A to 3C, the interface screen may include a menu screen to be used by the user to control the user interface apparatus or an external device connected to the user interface apparatus in a wired or wireless manner, a key input screen to be used by the user to enter various characters, and/or an application-related screen (for example, a web browser screen, a game screen, and/or a media player screen) that may be displayed in connection with an execution of an application in the user interface apparatus or the external device. The key input screen may include a first area in which a keyboard is displayed, and a second area in which one or more characters selected from the keyboard are displayed.

In operation 320, the user interface apparatus determines whether the input tool is detected in response to the user moving the input tool into a viewing angle of the user interface apparatus, namely, a sensing unit. When the input tool is determined to be detected, the user interface apparatus continues in operation 330. Otherwise (e.g., when the input tool is determined to not be detected after a predetermined period of time), the user interface apparatus ends the user interface method.

In operation 330, the user interface apparatus captures an image of the motion of the input tool. The user interface apparatus may also obtain a distance between the input tool and the user interface apparatus.

In operation 340, the user interface apparatus lays the captured motion image over the interface screen. The user interface apparatus may optimize a size of the captured motion image to fit the display region, and may lay the size-optimized motion image over the interface screen.

In operation 350, the user interface apparatus recognizes user input based on the motion image laid over the interface screen. In one example, user interface apparatus may analyze the image of the motion of the input tool that is laid over the interface screen, and may detect an area on the interface screen that is selected by the user by manipulating or moving the input tool so that the image of the motion of the input tool is over the area, based on results of the analysis. The user interface apparatus may recognize user input corresponding to the selected area on the interface screen. In another example, the user interface apparatus may identify an object corresponding to the selected area on the interface screen, and may recognize user input corresponding to the identified object. In these examples, the selected area may be more precisely detected based on not only the captured motion image but also the distance between the input tool and the user interface apparatus.

In response to the detection of the selected area, the user interface apparatus may notify the user of the recognition of the user input in various manners. In one example, the user interface apparatus may display the selected area in a different color from the rest of the interface screen. In another example, the user interface apparatus may display the selected area as being recessed, and/or may enlarge the selected area or content (e.g., text) displayed therein. In this manner, the user interface apparatus may allow the user to easily identify whether characters are being properly entered. In another example, the user interface apparatus may output a beeping sound and/or generate a vibration when the user selects the area on the interface screen.

In operation 360, the user interface apparatus processes an operation corresponding to the recognized user input. In one example, in response to the user selecting an object from a menu screen or clicking a link on a webpage screen, the user interface apparatus may process an operation corresponding to the object or the link. That is, when there is an interface screen linked to the object or the link, the user interface apparatus may generate the linked interface screen, and may read, from a database, data to be displayed on the generated interface screen.

In operation 370, the user interface apparatus generates a new interface screen based on results of the processing performed in operation 360. For example, the new interface screen may include the interface screen linked to the object or the link. The user interface apparatus returns to operation 310 to display the new interface screen in the display region. Operations 310, 320, 330, 340, 350, 360 and 370 may be repeatedly performed until the user takes off the wearable device, the user stops using the user interface apparatus, or the input tool is determined to not be detected after a predetermined period of time in operation 320.

The various units, portions, modules, and methods described above may be implemented using one or more hardware components, one or more software components, or a combination of one or more hardware components and one or more software components.

A hardware component may be, for example, a physical device that physically performs one or more operations, but is not limited thereto. Examples of hardware components include microphones, amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may include various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions that control a processing device to implement a software component may include a computer program, a piece of code, an instruction, or some combination thereof, that independently or collectively instructs or configures the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments that implement the examples disclosed herein can be easily constructed by a programmer skilled in the art to which the examples pertain based on the drawings and their corresponding descriptions as provided herein.

As a non-exhaustive illustration only, a terminal or device described herein may be a mobile device, such as a cellular phone, a personal digital assistant (PDA), a digital camera, a portable game console, an MP3 player, a portable/personal multimedia player (PMP), a handheld e-book, a portable laptop PC, a global positioning system (GPS) navigation device, a tablet, a sensor, or a stationary device, such as a desktop PC, a high-definition television (HDTV), a DVD player, a Blue-ray player, a set-top box, a home appliance, or any other device known to one of ordinary skill in the art that is capable of wireless communication and/or network communication.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus comprising:
a display unit configured to display a user interface screen in an area;
a sensing unit configured to capture an image of a motion of an object used to enter user input;
an input recognition unit configured to lay the image over the user interface screen, and recognize the user input based on the image laid over the user interface screen; and
a processing unit configured to process an operation corresponding to the recognized user input.

2. The apparatus of claim 1, further comprising:
an interface generation unit configured to generate a new user interface screen based on the processing,
wherein the display unit is further configured to display the new user interface screen in the area.

3. The apparatus of claim 1, wherein the display unit is further configured to:
generate the area in a virtual space seen using the apparatus.

4. The apparatus of claim 1, wherein the user interface screen comprises a menu screen to be used to control an operation, or a key input screen to be used to enter a character, or an application-related screen, or any combination thereof.

5. The apparatus of claim 4, wherein the key input screen comprises a first area in which a keyboard is displayed, and a second area in which the character selected from the keyboard by the object is displayed.

6. The apparatus of claim 1, wherein:
the sensing unit is further configured to sense a distance between the apparatus and the object; and
the input recognition unit is further configured to recognize the user input based on the image laid over the user interface screen, and the distance.

7. The apparatus of claim 1, wherein the input recognition unit is further configured to:
notify a user of the recognition.

8. The apparatus of claim 1, wherein the input recognition unit is further configured to:
detect an area on the user interface screen that is selected by the object; and
recognize the user input corresponding to the area.

9. The apparatus of claim 8, wherein the input recognition unit is further configured to:
display the area in a different color from the user interface screen, or display the area as recessed, or enlarge the area, or output a beeping sound, or generate a vibration, or any combination thereof, in response to the area being detected.

10. The apparatus of claim 1, wherein the object comprises a hand, or a finger, or a pen, or any combination thereof.

11. A method comprising:
displaying a user interface screen in an area;
capturing an image of a motion of an object used to enter user input;
laying the image over the user interface screen;
recognizing the user input based on the image laid over the user interface screen; and
processing an operation corresponding to the recognized user input.

12. The method of claim 11, further comprising:
generating a new user interface screen based on the processing; and
displaying the new user interface screen in the area.

13. The method of claim 11, further comprising:
generating the area in a virtual space seen using an apparatus performing the method.

14. The method of claim 11, wherein the user interface screen comprises a menu screen to be used to control an operation, or a key input screen to be used to enter a character, or an application-related screen, or any combination thereof.

15. The method of claim 14, wherein the key input screen comprises a first area in which a keyboard is displayed, and a second area in which the character selected from the keyboard by the object is displayed.

16. The method of claim 11, further comprising:
sensing a distance between an apparatus performing the method and the object,
wherein the recognizing comprises recognizing the user input based on the image laid over the user interface screen, and the distance.

17. The method of claim 11, further comprising:
notifying a user of the recognition.

18. The method of claim 11, further comprising:
detecting an area on the user interface screen that is selected by the object,
wherein the recognizing comprises recognizing the user input corresponding to the area.

19. The method of claim 18, further comprising:
displaying the area in a different color from the user interface screen, or displaying the area as recessed, or enlarging the area, or outputting a beeping sound, or generating a vibration, or any combination thereof, in response to the area being detected.

20. The method of claim 11, wherein the object comprises a hand, or a finger, or a pen, or any combination thereof.
